(19) United States
(12) Patent Application Publication
(10) Pub. No.: US 2015/0290538 A1
(43) Pub. Date: Oct. 15, 2015

(54) MOBILE APPLICATION-ENABLED DRINKING GAME

(71) Applicants: Jason M. BONSALL, Mint Hill, NC (US); Kevin J. BONSALL, Charlotte, NC (US); Christopher T. BONSALL, Matthews, NC (US)

(72) Inventors: Jason M. BONSALL, Mint Hill, NC (US); Kevin J. BONSALL, Charlotte, NC (US); Christopher T. BONSALL, Matthews, NC (US)

(21) Appl. No.: 14/680,224

(22) Filed: Apr. 7, 2015

Related U.S. Application Data
(60) Provisional application No. 61/977,355, filed on Apr. 9, 2014.

(51) Int. Cl. A63F 13/46; A63F 13/217; A63F 13/44

(52) U.S. Cl. CPC A63F 13/46; A63F 13/44; A63F 13/217

(57) ABSTRACT

A method is provided of playing a drinking game. A mobile app is downloaded to a mobile device. The mobile device receives, via the mobile app, identification of a user wishing to play a drinking game and identification of one or more songs selected by, or assigned to, the user. Via the mobile app, the one or more songs are associated, in a database, with the corresponding user using the respective song and user identifications. Thereafter, a series of songs is played via a designated music source. In response to any of the one or more songs being played by the designated music source in the series of songs, the mobile device provides, to the user associated with the song being played, information regarding a game-related step to be taken in the drinking game. The songs are played and information provided for the duration of the game.

### CROSS-REFERENCE TO RELATED APPLICATION

The present application is a U.S. nonprovisional patent application of, and claims priority under 35 U.S.C. §119(e) to, U.S. provisional patent application Ser. No. 61/977,355, filed Apr. 9, 2014, which provisional patent application is incorporated by reference herein.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE PRESENT INVENTION

### Field of the Present Invention

The present invention relates generally to a mobile device application (mobile app) that provides an interface for playing an original drinking game.

### BACKGROUND

Social games involving the consumption of alcohol have been popular for many years, particularly among young adults. Various such games, which may be based upon players' skill or complete luck, or some combination thereof, have been proposed and played through the years. Among games based on luck, various events, factors, occurrences, or the like have been used to drive game play.

A mobile application (sometimes referred to herein as an “app”) is application software that runs on smartphones, tablets, and other mobile electronic devices. Mobile applications may be free or purchased, and are available for download on mobile electronic devices that contain mobile operating systems, which allow the mobile applications to execute. Currently, mobile applications exist for many uses including games, social media such as Facebook, and database related mobile applications such as address books or sporting event results.

One drawback to drinking games is the limitations that are naturally placed on their complexity by the conditions under which they are typically played, which include party atmospheres, frequent distractions, and the physical condition of the players. Furthermore, many drinking games require a significant amount of attention to be paid, by one or more of the players, to the television programming or other source of randomized events in order to control game play. It is believed that use of a mobile app, coordinated with a stream of music from a music source, will permit increased complexity, interest in game play, and ease of game play.

### SUMMARY OF THE PRESENT INVENTION

Some exemplary embodiments of the present invention may overcome one or more of the above disadvantages and other disadvantages not described above, but the present invention is not required to overcome any particular disadvantage described above, and some exemplary embodiments of the present invention may not overcome any of the disadvantages described above.

Broadly defined, the present invention according to one aspect is a method of playing a drinking game, including: downloading a software application, defining a mobile app, to at least one mobile device; receiving, by the mobile device via the mobile app, identification of a user wishing to play a drinking game; receiving, by the mobile device via the mobile app, identification of one or more songs selected by, or assigned to, the user; in a database, associating, via the mobile app, the one or more songs with the corresponding user using the respective song and user identifications; and thereafter, playing a series of songs via a designated music source, wherein, during such playing of the series of songs: in response to any of the one or more songs being played by the designated music source in the series of songs, providing, by the mobile device to the user associated with the song being played, information regarding a game-related step to be taken in the drinking game, and for the duration of the game, continuing the playing of the series of songs and the providing of information regarding game-related steps to be taken.

In a feature of this aspect, the information regarding a game-related step includes an instruction to a player to drink a liquid. In a further feature, the liquid is an alcoholic drink.

In another feature of this aspect, the method further includes a step, in response to any of the one or more songs being played by the designated music source in the series of songs, awarding a game point to the user associated with the song being played.

In another feature of this aspect, the receiving steps are each carried out for a plurality of different users. In a further feature, the method further includes a step of facilitating, via the mobile device, a draft process for the users to select the one or more songs for each respective user.

In another feature of this aspect, the method further includes a step, during the playing of songs via the designated music source, of monitoring, via the mobile app operating on the mobile device, the particular songs being played. In a further feature, the providing information step is carried out automatically on the basis of the monitoring step.

In another feature of this aspect, the receiving and providing steps are facilitated via a graphical user interface generated by the mobile device.

Broadly defined, the present invention according to another aspect is a method of playing a drinking game, including: downloading a software application, defining a mobile app, to at least one mobile device; receiving, by each of the at least one mobile device via the mobile app, identification of a user wishing to play a drinking game; receiving, by the mobile devices via the mobile app, identification of one or more songs to be used in the drinking game; in a database, associating, via the mobile app, the one or more songs with one or more of the users wishing play the drinking game; and thereafter, playing a series of songs via a radio source, wherein, during such playing of the series of songs: in response to any of the one or more songs being played by the designated music source in the series of songs, providing, by the mobile device to at least one of the users, information regarding a game-related step to be taken in the drinking game, and for the duration of the game, continuing the playing of the series of songs and the providing of information regarding game-related steps to be taken.

Broadly defined, the present invention according to another aspect is a method of playing a drinking game, including: downloading a software application, defining a mobile app, to a mobile device; inputting, into the mobile device via the mobile app, identification of a user wishing to play a drinking game into the mobile device; inputting, into the mobile device via the mobile app, identification of one or more songs selected by, or assigned to, the user; in a database, associating, via the mobile app, the one or more songs with the corresponding user using the respective song and user identifications; and thereafter, playing a series of songs via a designated music source, wherein, during such playing of the series of songs: when any of the series of songs is one of the songs associated with a particular user in the database, displaying, by the mobile device to the user associated with the song being played, instructions regarding a game-related step to be taken in the drinking game, and for the duration of the game, continuing the playing of the series of songs and the displaying of information regarding game-related steps to be taken.

In a feature of this aspect, the information regarding a game-related step includes an instruction to a player to drink a liquid. In a further feature, the liquid is an alcoholic drink.

Broadly defined, the present invention according to another aspect is a system for playing an original drinking game, including: at least one mobile device; a music source; and a mobile app installed on each of the at least one mobile device and operable to control playing of a drinking game based on particular songs played by the music source.

In a feature of this aspect, the mobile app is downloadable from a server via the internet.

In another feature of this aspect, a server links players together via the internet via the at least one mobile device and the mobile app installed thereon.

Broadly defined, the present invention according to another aspect is a system for playing an original drinking game as shown and described.

Broadly defined, the present invention according to another aspect is a method of playing an original drinking game, including: downloading a mobile app to each of at least one mobile device; by each player, individually selecting, via the mobile app installed on the player's mobile device, one or more songs that may possibly be played by a music source; and engaging in a drinking game based on the actual playing or not playing of the individually selected songs played by the music source.

Broadly defined, the present invention according to another aspect is a method of playing an original drinking game as shown and described.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Further features, embodiments, and advantages of the present invention will become apparent from the following detailed description with reference to the drawings, wherein:

FIG. 1 is a block diagram of a mobile application-based system for playing an original drinking game in accordance with one or more preferred embodiments of the present invention;

FIG. 2 is an illustration of a portion of an exemplary login screen on a mobile device for use in the mobile application of the system of FIG. 1;

FIG. 3 is an illustration of a portion of an exemplary invitation screen on a mobile device for use in the mobile application of the system of FIG. 1;

FIG. 4 is an illustration of an exemplary radio station information screen on a mobile device for use in the mobile application of the system of FIG. 1;

FIG. 5 is an illustration of a portion of an exemplary duration set-up screen on a mobile device for use in the mobile application of the system of FIG. 1;

FIG. 6 is an illustration of an exemplary draft search screen on a mobile device for use in the mobile application of the system of FIG. 1;

FIG. 7 is an illustration of an exemplary search results screen on a mobile device for use in the mobile application of the system of FIG. 1;

FIG. 8 is an illustration of a portion of an exemplary roster screen on a mobile device for use in the mobile application of the system of FIG. 1;

FIG. 9 is an illustration of a portion of an exemplary song-tracking screen on a mobile device for use in the mobile application of the system of FIG. 1;

FIG. 10 is an illustration of another portion of an exemplary sentence status screen on a mobile device for use in the mobile application of the system of FIG. 1;

FIG. 11 is an illustration of a portion of an exemplary sentence completion screen on a mobile device for use in the mobile application of the system of FIG. 1;

FIG. 12 is an illustration of a portion of an exemplary alternative penalty screen on a mobile device for use in the mobile application of the system of FIG. 1; and

FIG. 13 is an illustration of a portion of an exemplary standings screen on a mobile device for use in the mobile application of the system of FIG. 1.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers,” “a picnic basket having crackers without cheese,” and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, in which like numerals represent like components throughout the several views, the preferred embodiments of the present invention are next described. The following description of one or more preferred embodiment(s) is merely exemplary in nature and is in no way intended to limit the invention, its application, or uses.

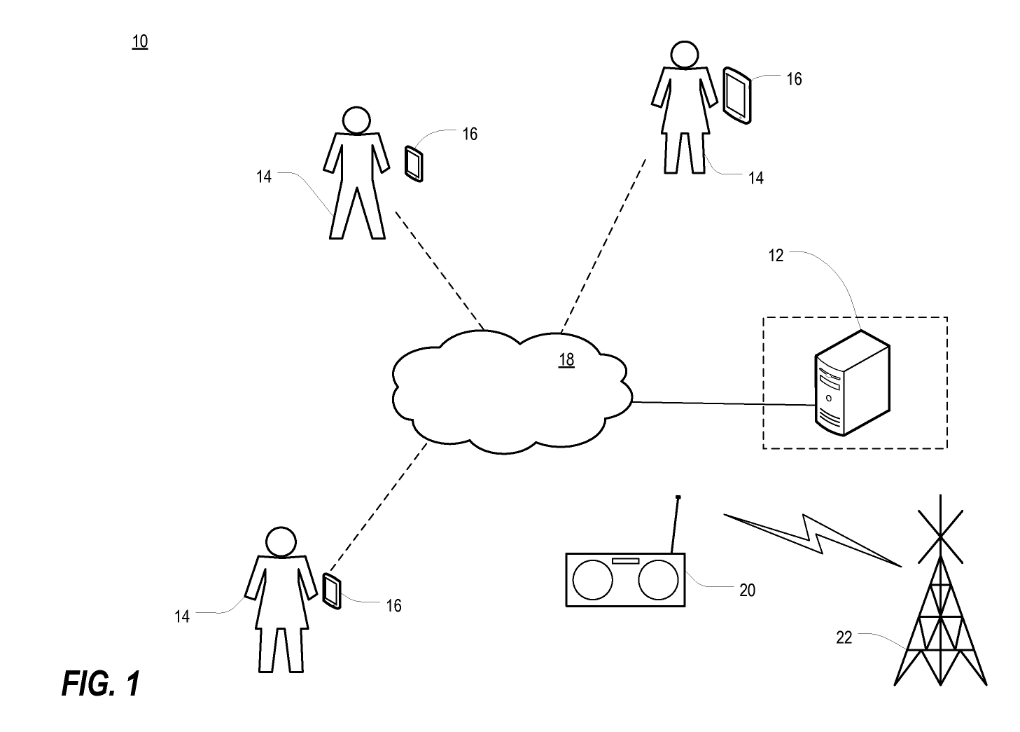

FIG. 1 is a block diagram of a mobile application-enabled system 10 for playing a game based on music broadcasts in accordance with one or more preferred embodiments of the present invention. The system 10 may be used by mobile device owners or users 14 that want to play an original drinking game. In general, a game in accordance with one or more preferred embodiments of the present invention involves rewarding participants for correctly guessing one or more of the songs that will play from a chosen music source, such as a top-40 radio station. Predictions may be made through a draft system in which participants are roughly analogous to sports teams and songs to hopeful athletes. In the event of a correct prediction, the person that drafted the song earns points and/or penalizes other players by assigning drinking sentences (such as involving the consumption of alcohol) which must be completed before the song ends. Examples of suitable rules for such a game are provided in appendices hereto, discussed hereinbelow. Other embodiments may include variations on the rules to allow other drinking games to be played using the mobile application-based system 10.

Players 14 download a mobile application from a server 12 or the like over the internet 18 onto their smart phones or other mobile devices 16, thus setting up the mobile application-based system 10 for playing a drinking game as described herein. Once the mobile application has completed downloading onto a particular mobile device 16, a selectable icon, graphic, text, or the like preferably appears on the screen of the mobile device 16. When the mobile device owner or user 14 selects the icon or other selectable object, the mobile app begins presenting, to the user 14, a graphical user interface or other interface that allows the user to prepare for and/or participate in (i.e., play) a drinking game using the mobile device 16. Such a graphical user interface preferably provides a set of screens, at least some of which are described and illustrated herein, that together enable users 14 to participate in a game played and otherwise executed as described herein.

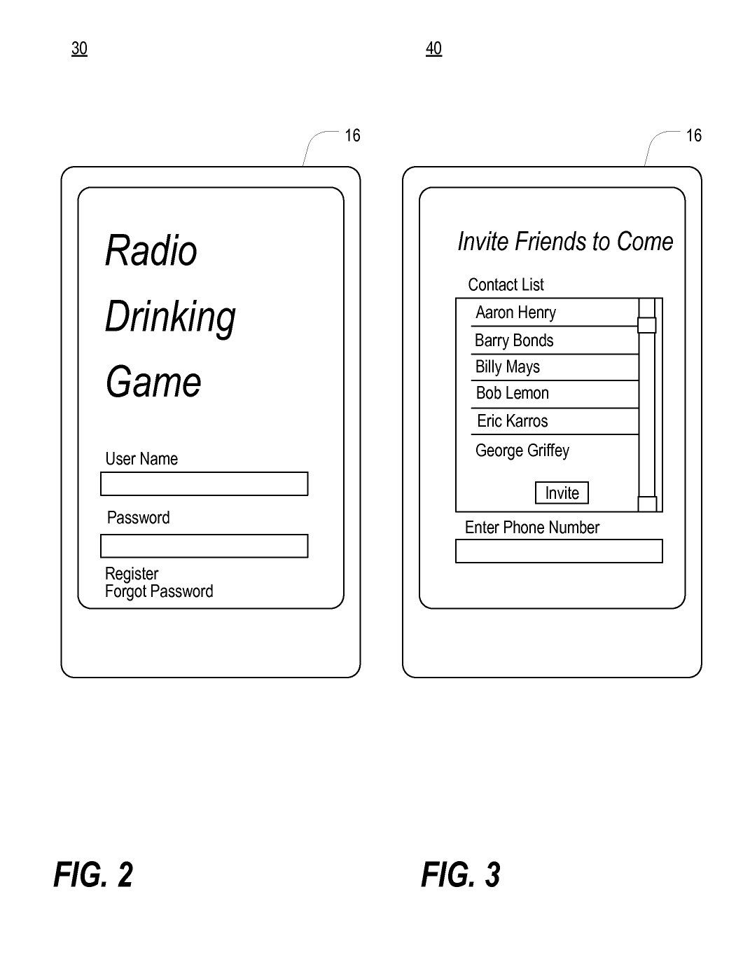

In at least some embodiments, all players 14 must register with the system software operating on the server 12 or other connected computer in order to be able to contact other players 14 and to play the game. FIG. 2 is an illustration of a portion of an exemplary login screen 30 on a mobile device 16 for use in the mobile application of the system 10 of FIG. 1. Participating players enter their User Name and a Password, or they may select “Register,” which in turn prompts them to create a User Name and Password. Notably, it will be appreciated that in at least some embodiments, more than one player 14 may use the same mobile device 16 to participate in a playing of the game.

Once a player 14 signs in, a game can be initiated. In some embodiments, signing in starts a new game automatically, while in other embodiments, the player 14 may start a new game manually. If the player is initiating a new game (manually or automatically), the player 14 may invite friends to join the game; if a player signs in in response to such an invitation, the player 14 is placed in the game automatically. FIG. 3 is an illustration of a portion of an exemplary invitation screen 40 on a mobile device 16 for use in the mobile application of the system 10 of FIG. 1. Any player who is registered in the system 10 may be invited to play the game by selecting their name and clicking or otherwise actuating the invite button. In at least some embodiments, a phone number may also be entered to send an invitation to a user at that phone number if a particular mobile device owner or user 14 is not registered. The user 14 would get a text inviting or prompting them to download the mobile app and register.

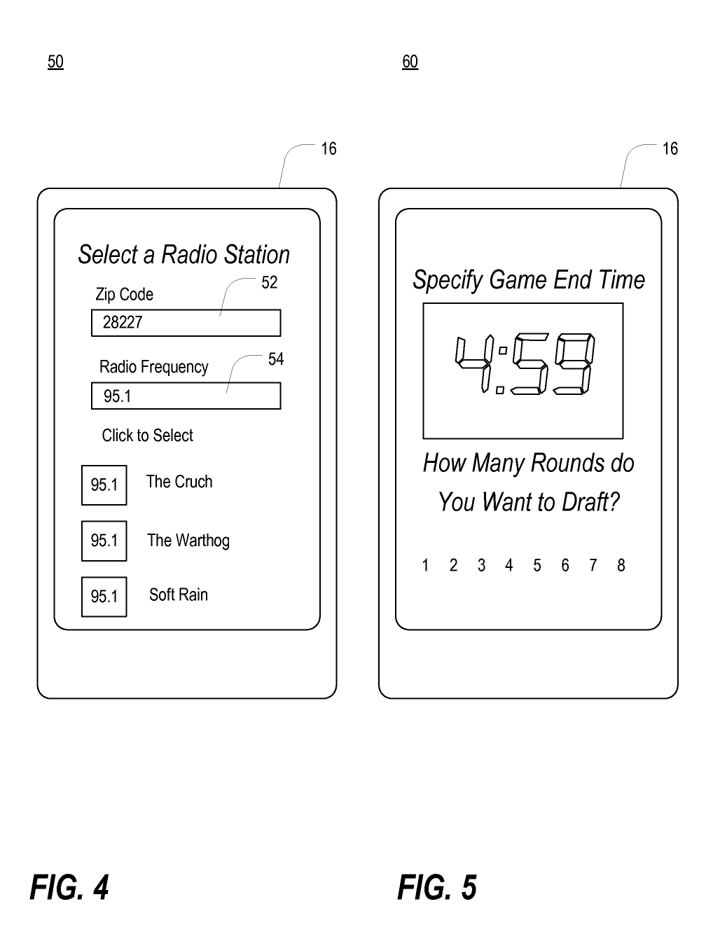

As noted previously, game play in at least some embodiments is based on the particularly songs being broadcast to a radio 20 or other audio device by a particular radio station 22 or other music source. FIG. 4 is an illustration of an exemplary radio station information screen 50 on a mobile device for use in the mobile application of the system 10 of FIG. 1. Radio stations may broadcast “over the air” (e.g., FM or AM), via satellite, over the internet, as a channel on a cable system, or in any other suitable manner. In the screen 50 of FIG. 4, the player 14 is prompted to enter their zip code in field 52 and a radio frequency or station in field 54. A further screen or field (not shown) could be provided to select or designate a radio band, such as FM, AM, XM, HD radio, internet, and/or the like. In other preferred embodiments, the mobile app is set up to work with one or more different music sources, with such alternative music sources including CDs, television music channels, digital file collections, and the like. A further screen or field (not shown) could be provided to select or designate a music source type. The mobile app accesses the radio station 22 or other music source being used to play the game in order to recognize when particular songs are played. In general, the playing of particular songs leads to activities, scoring events, or the like in the game.

FIG. 5 is an illustration of a portion of an exemplary duration set-up screen 60 on a mobile device for use in the mobile application of the system 10 of FIG. 1. The player selects an end time and the number of draft rounds. In the illustrated screen 60, the player may choose from one to eight rounds, but other numbers of rounds may likewise be established, and other means may be used to set the number of rounds. In other preferred embodiments, the player 14 is prompted to enter an alternative ending event (i.e., other than a specific time), such as a particular score being reached, a particular number of songs that are played during the game, or the like.

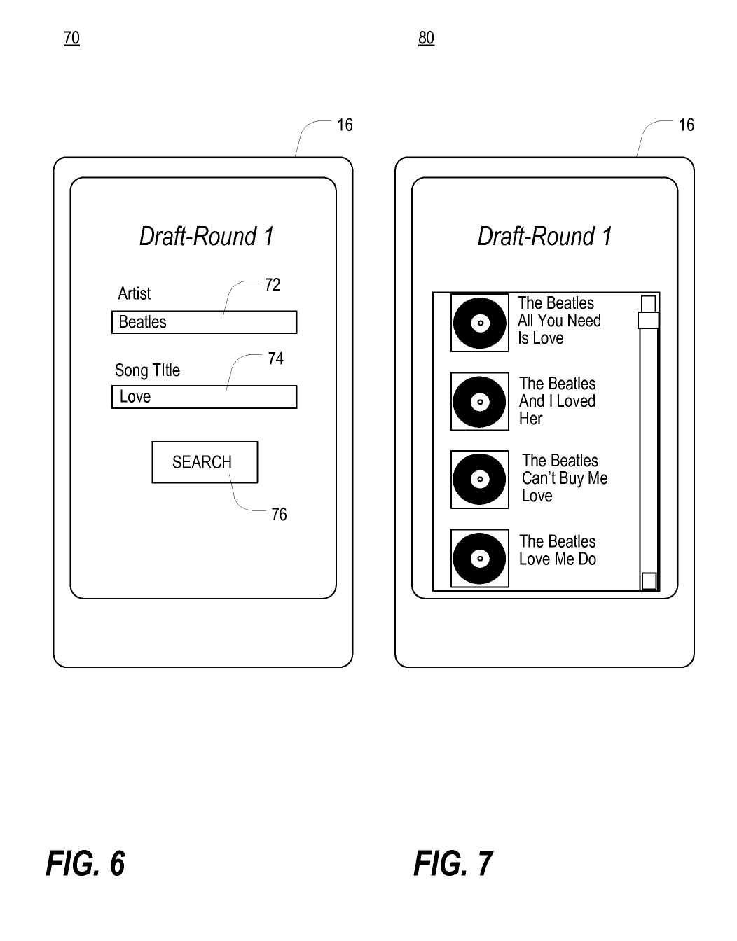

FIG. 6 is an illustration of a portion of an exemplary draft search screen 70 on a mobile device for use in the mobile application of the system 10 of FIG. 1. In general, a player scores points in the drinking game when a particular song they have chosen is played on the radio 20 or other music-playing device. Each player takes turns choosing artists and songs they think will be played first. In the illustrated embodiment, the draft set-up screen prompts each player to enter a complete or partial artist name 72 and/or a complete or partial song title 74. The player then clicks the SEARCH button 76 to generate a list of songs that match the artist and/or song title information entered. In some embodiments, other search criteria may additionally or alternatively may specified, such as year of release, music genre, or the like. In some embodiments, wildcard characters (e.g., “#”) may be utilized to permit players 14 to enter incomplete words. Spellchecking and/or autofill functions may be provided.

FIG. 7 is an illustration of an exemplary search results screen 80 on a mobile device 16 for use in the mobile application of the system 10 of FIG. 1. After the information is entered on the draft search screen 70, the search results screen 80 displays the list of songs that match the artist and title. The player 14 may then select the song they wish to draft in the round from the list of songs displayed on the search results screen 80, or they player 14 may return to the draft search screen 70 to modify the search criteria as desired. In at least some embodiments, the players 14 take turns drafting songs for the number of rounds chosen in the duration set-up screen 60. In other embodiments, each player 14 may make their selections independently. In at least some embodiments, each song may be drafted or selected by only one player 14, while in others, more than one player 14 may have the same song on their roster. Regardless, an identification of each song selected by, or assigned to, each particular player 14 is associated with an identification of the respective player by the mobile app in a database.

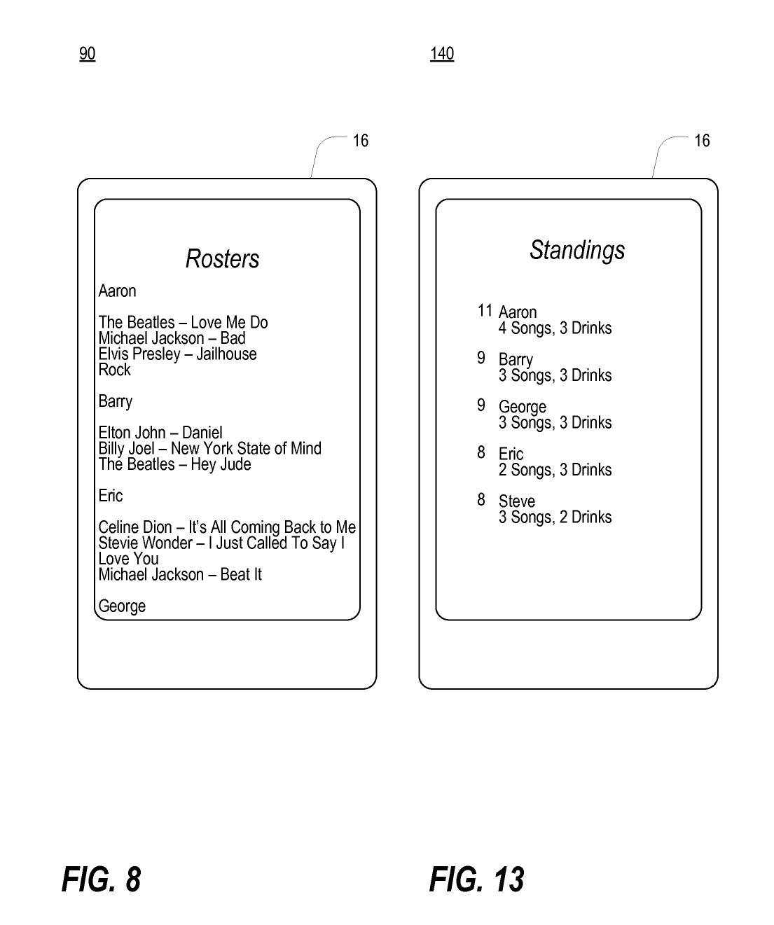

FIG. 8 is an illustration of a portion of an exemplary roster screen 90 on a mobile device 16 for use in the mobile application of the system 10 of FIG. 1. As a player 14 fills his or her roster, and/or after all of the draft rounds are completed, the roster screen 90 displays one or more lists of drafted songs. The lists may include a list of all drafted songs, a list of a particular player's roster, lists of all of the players' rosters, or the like.

In at least some embodiments, other parameters may also be set by the players 14. Some of these may pertain to the drinks to be used (consumed) during game play. In at least some embodiments, the drinks are alcoholic drinks, although in some other games drinks may be non-alcoholic, because in at least some cases a challenge of the game may be the quantity of liquid (or in some cases food) consumed. Drink-related options may include, for example, drink size, drink type, and the like. Options may also be set-up in any order without affecting the game.

After the game set-up is complete, the players are ready to start an actual game. In one or more preferred embodiments of the mobile app, a very small number of rules are used. In other preferred embodiments of the mobile app, a more comprehensive set of rules is used. An example of a condensed version of a drinking game rulebook is provided in the document entitled “Condensed Rules,” attached hereto as Appendix A and incorporated herein by reference in its entirety, and an example of a more comprehensive version of a drinking game rulebook is provided in the document entitled “Expanded Rules,” attached hereto as Appendix B and likewise incorporated herein by reference in its entirety. In general, the more comprehensive rulebook includes more options to the game. These options may include the trading of drink challenges (sometimes referred to as “sentences”), suggestion of draft picks, more opportunities for bonus points, additional song types, various rewards for successful drafts, rules concerning an individual's removal and addition to the game, and the like. These rules generally serve to make the game more complex, but in general they do not change the basic play of the game. It will be appreciated that an infinite number of different sets of rules may alternatively be utilized.

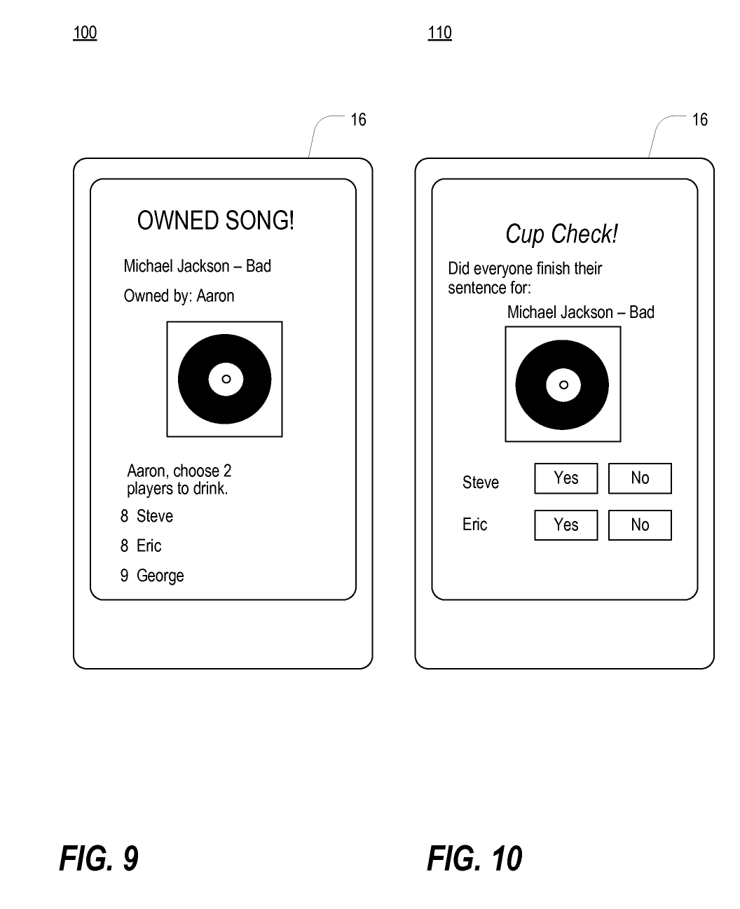

Game play involves monitoring the selected radio station 22 or other music source so as to identify the songs being played. The players 14 may be engaged in other activities while monitoring. Preferably, all players are listening simultaneously, but one or more players can be away from the radio 20 or other audio device or otherwise out of earshot. The players 14 are particularly monitoring the radio station 22 for songs that are included on one or more roster of the participating players 14. Monitoring may occur manually, by the players 14, or automatically, wherein a signal transmitted along with the audio signal representing the song itself or some other identifying information (for example, data stored in a digital storage being used as a music source) is used to provide automatic identification of the song. When such a song is played by the radio station 22 or other music source, the owner of the song may be awarded game points. In addition, a game-tracking screen 100 displays the song title and artist, the owner of the song, and gives directions for the next activity or event in the game. In this regard, FIG. 9 is an illustration of a portion of an exemplary song-tracking screen 100 on a mobile device 16 for use in the mobile application of the system 10 of FIG. 1. In various preferred embodiments, the activity or event involves presenting the player(s) 14 whose song was played with the option of assessing a “penalty” against one or more other players 14. For example, in FIG. 9, the song “Bad” by Michael Jackson, which was included on Aaron's roster, was played on the radio 20, and as a result Aaron is given the option of requiring two other players to have a drink. In particular, Aaron is allowed to select the two players, with the two players being chosen from among Steve, Eric, and George.

Once the player 14 whose song was played has selected the players to be penalized, an indication may be provided to the selected players to take a drink. The specific directions for the penalty being dependent on the set-up options. Optionally, directions may include options for trading sentences and/or ways to earn bonus points. As a game is played, the mobile app keeps track of the drinking sentences, and prompts the players to enter status on the game-tracking screens. More particular, in conjunction with notifying the penalized players of their assigned sentence, those players may then be asked to indicate whether or not they chose (or were able) to take their drink or otherwise carry out their assigned sentence. In this regard, FIG. 10 is an illustration of a portion of an exemplary status completion screen 110 on a mobile device 16 for use in the mobile application of the system 10 of FIG. 1. If a penalized player completes their assigned sentence, they select “YES,” whereas if they choose not to do so (assuming the particular rules being used for the game permit it), they may select “NO.” Continuing the example of FIG. 9, if Aaron assigns sentences to Steve and Eric, then Steve and Eric are shown on the sentence completion screen 110, and each of them may choose “YES” or “NO.”

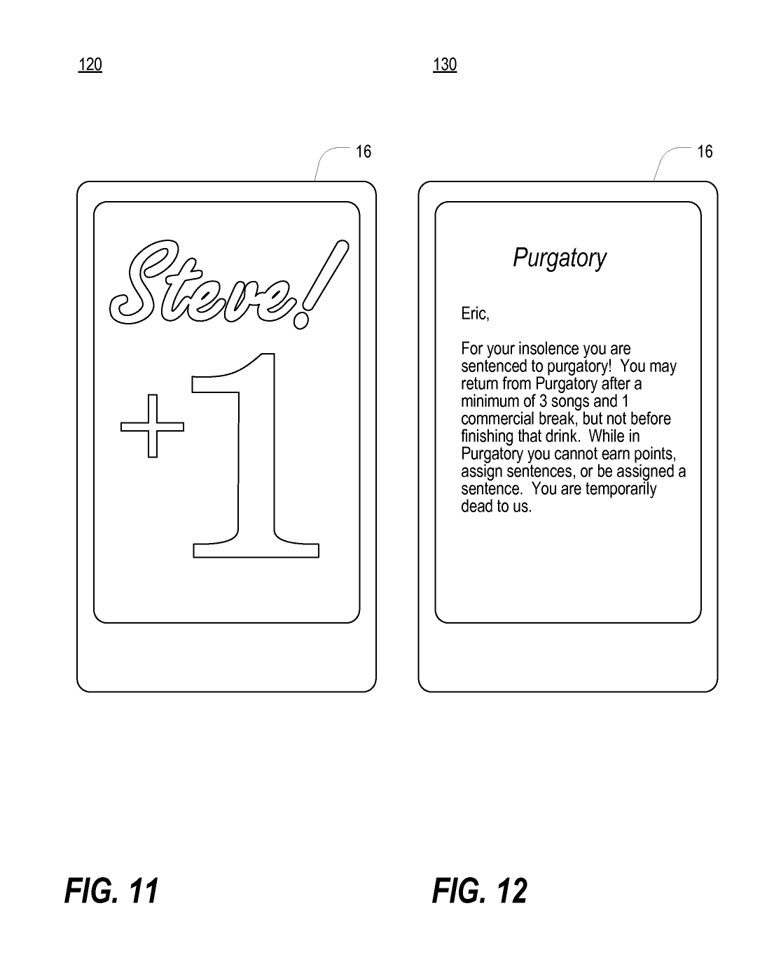

If a player selects “YES,” indicating that the player has completed his or her assigned sentence, then he may be rewarded by awarding game points. In this regard, FIG. 11 is an illustration of a portion of an exemplary sentence completion screen 120 on a mobile device 16 for use in the mobile application of the system 10 of FIG. 1. As shown therein, Steve has indicated he completed his sentence and is awarded +1 point for doing so. As with other events during the game, the mobile app recognizes when any scoring event occurs and records it appropriately. Meanwhile, if a player selects “NO,” indicating that the player did not complete his or her assigned sentence, then he may, under at least some rules, be penalized in a different way. For example, he may be required to withdraw from the game for some period of time, which would give him some time to recover physically (if necessary) but would prevent him from scoring game points in the meantime. In this regard, FIG. 12 is an illustration of a portion of an exemplary alternative penalty screen 130 on a mobile device 16 for use in the mobile application of the system 10 of FIG. 1. The penalty screen 140 details the specific penalty that is assigned. As shown therein, Eric has indicated that he did not complete his sentence and has been placed in “purgatory.” The particular terminology and duration of withdrawal period may vary, and in at least some cases may be set by the players during set-up.

As the game progresses, the mobile app preferably keeps track of the standings. In this regard, FIG. 13 is an illustration of a portion of an exemplary standings screen 140 on a mobile device for use in the mobile application of the system 10 of FIG. 1. As described previously, the players score points when their drafted songs are played by the radio station 22 or other music source, when they complete an assigned sentence, and/or in other situations. The standings screen 140 lists each player starting with the player that has the most points and ending with the player that has the least points. As shown, the standings screen 140 may also include the number of songs played for each player 14 and the number of drinks that each player 14 has consumed. Other statistical information may additionally or alternatively be shown. As described previously, the game may continue for a predetermined duration, until a particular number of points are reached, until some other milestone is reached, or some other criteria is achieved. A winner is generally declared based on the highest point score.

In at least some embodiments, the mobile app, the server 12, and/or parts of the system 10 keeps track of each player's user history in order to provide a statistical record of the player's finishing position in games played (i.e. 1st, 2nd, 3rd, etc.), career average, and the like. In at least one embodiment, the system 10 awards game points to players 14 for playing the game, for certain achievements within the game, and the like. These points are redeemable for game-branded merchandise and/or other merchandise that may be made available, for example, at a website dedicated to the game. In some embodiments, the points are redeemable for free merchandise, while in others, the points are redeemable for the right to purchase merchandise. Such a website may be provided via the server 12 or via other connected or independent computer.

Based on the foregoing information, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements; the present invention being limited only by the claims appended hereto and the equivalents thereof.

What is claimed is:

1. A method of playing a drinking game, comprising:
downloading a software application, defining a mobile app, to a mobile device;
receiving, by the mobile device via the mobile app, identification of a user wishing to play a drinking game;
receiving, by the mobile device via the mobile app, identification of one or more songs selected by, or assigned to, the user;
in a database, associating, via the mobile app, the one or more songs with the corresponding user using the respective song and user identifications; and
thereafter, playing a series of songs via a designated music source, wherein, during such playing of the series of songs:
in response to any of the one or more songs being played by the designated music source in the series of songs, providing, by the mobile device to the user associated with the song being played, information regarding a game-related step to be taken in the drinking game, and
for the duration of the game, continuing the playing of the series of songs and the providing of information regarding game-related steps to be taken.

2. The method of claim 1, wherein the information regarding a game-related step includes an instruction to a player to drink a liquid.

3. The method of claim 2, wherein the liquid is an alcoholic drink.

4. The method of claim 1, further comprising a step, in response to any of the one or more songs being played by the designated music source in the series of songs, awarding a game point to the user associated with the song being played.

5. The method of claim 1, wherein the receiving steps are each carried out for a plurality of different users.

6. The method of claim 5, further comprising a step of facilitating, via the mobile device, a draft process for the users to select the one or more songs for each respective user.

7. The method of claim 1, further comprising a step, during the playing of songs via the designated music source, of monitoring, via the mobile app operating on the mobile device, the particular songs being played.

8. The method of claim 7, wherein the providing information step is carried out automatically on the basis of the monitoring step.

9. The method of claim 1, wherein the receiving and providing steps are facilitated via a graphical user interface generated by the mobile device.

10. A method of playing a drinking game, comprising:
downloading a software application, defining a mobile app, to at least one mobile device;
receiving, by each of the at least one mobile device via the mobile app, identification of a user wishing to play a drinking game;
receiving, by the mobile devices via the mobile app, identification of one or more songs to be used in the drinking game;
in a database, associating, via the mobile app, the one or more songs with one or more of the users wishing play the drinking game; and
thereafter, playing a series of songs via a radio source, wherein, during such playing of the series of songs:
in response to any of the one or more songs being played by the designated music source in the series of songs, providing, by the mobile device to at least one of the users, information regarding a game-related step to be taken in the drinking game, and
for the duration of the game, continuing the playing of the series of songs and the providing of information regarding game-related steps to be taken.

11. A method of playing a drinking game, comprising:
downloading a software application, defining a mobile app, to a mobile device;
inputting, into the mobile device via the mobile app, identification of a user wishing to play a drinking game into the mobile device;
inputting, into the mobile device via the mobile app, identification of one or more songs selected by, or assigned to, the user;
in a database, associating, via the mobile app, the one or more songs with the corresponding user using the respective song and user identifications; and
thereafter, playing a series of songs via a designated music source, wherein, during such playing of the series of songs:
when any of the series of songs is one of the songs associated with a particular user in the database, displaying, by the mobile device to the user associated with the song being played, instructions regarding a game-related step to be taken in the drinking game, and
for the duration of the game, continuing the playing of the series of songs and the displaying of information regarding game-related steps to be taken.

12. The method of claim 11, wherein the information regarding a game-related step includes an instruction to a player to drink a liquid.

13. The method of claim 12, wherein the liquid is an alcoholic drink.
